(19) United States
(12) Patent Application Publication
(10) Pub. No.: US 2024/0054443 A1
(43) Pub. Date: Feb. 15, 2024

(54) DELIVERY MANAGEMENT ASSIST SYSTEM, DELIVERY MANAGEMENT ASSIST METHOD, AND DELIVERY MANAGEMENT ASSIST PROGRAM

(71) Applicant: GBtechnology Co., Ltd., Tokyo (JP)

(72) Inventor: Tadayoshi Kurose, Tokyo (JP)

(73) Assignee: GBtechnology Co., Ltd., Tokyo (JP)

(21) Appl. No.: 18/384,090

(22) Filed: Oct. 26, 2023

Related U.S. Application Data
(63) Continuation of application No. PCT/JP2022/000469, filed on Jan. 11, 2022.

(30) Foreign Application Priority Data
Apr. 28, 2021 (JP) 2021-076871

(51) Int. Cl. G06Q 10/0835; G06Q 10/0834; G06F 40/40

(52) U.S. Cl. CPC G06Q 10/08355; G06Q 10/08345; G06F 40/40

(57) ABSTRACT

A delivery management assist system includes: a receiver that receives: package information including destination, contents, weight, desired delivery amount of cost, and desired delivery time for delivery of a package requested by a delivery requester, and deliverer information including a plurality of deliverers capable of delivering the package, a sectional route that each of the deliverers is capable of being in charge of delivery, a deliverer in charge of the sectional route, and delivery fee and delivery time of the deliverer in charge of the sectional route; a sectional route generator that generates a plurality of sectional routes by sectioning a route between a current location of the delivery requester and the destination in accordance with the deliverers; and a sectional route combining unit that combines two or more of the sectional routes.

### TECHNICAL FIELD

This disclosure relates to a delivery management assist system, a delivery management assist method, and a delivery management assist program, especially a delivery management assist system, a delivery management assist method, and a delivery management assist program that assist delivery management of goods by selecting an appropriate deliverer from among a plurality of deliverers.

### BACKGROUND

Although a considerable number of websites that combine (match) vendors in the transportation and warehousing industry are present, all of such websites are only for matching. This situation fails to involve negotiations or contracts and causes each individual user to be matched with the other users.

More than a million trucks run on the road in Japan, for example, and the transportation industry is understaffed. However, packages fail to be always in the back of the trucks. This is because of various issues such as licenses, permissions, and contracts between companies as well as the demand for the packages to be transported.

If the above issues are resolved, many ways to make effective use of trucks for business use alone are still present in the contract of simply “transporting goods=paying for them,” and if other means are included, the possibilities are endless.

The expansion of purchases of goods through e-commerce sites (EC sites), the purchasing and selling of goods between individuals, and the increase in telecommuting have led to a rapid increase in demand for home delivery services recently, increasing the loads on delivery services, transport companies, and other deliverers. In contrast, from a perspective of a user, for example, when a small amount of goods is purchased through an e-commerce site, the ratio of shipping costs to the purchase price is significantly high, and this may be often inconvenient. To improve this situation, the loads and costs associated with the delivery need to be reduced.

A related technology is, for example, to determine regional pairs of regions each on the basis of the location of sales agents in a plurality of regions, product display space information, and vendor information such as product information for each region, and to output transportation instructions for mutual delivery of products on the basis of placing and receiving order information between these regional pairs, thereby mutually distributing specialties and specialty products between pairs of regions and managing them all together to reduce distribution costs and facilitate the placing and receiving of orders for products in the regions.

In contrast, for airmail, for example, where it is not directly applicable to logistics for general online shopping, or where no carrier capable of moving the entire delivery section to complete the delivery of goods is present but a plurality of carriers capable of delivering only one section in the middle of the delivery section is present, a delivery management assist system, a delivery management assist method, and a delivery management assist program are disclosed to embody a sharing economy type logistics service more cost-effectively and flexibly by effectively utilizing the carriers capable of delivering only in a part of the way of a delivery target section (see Japanese Registered Patent No. 6476232).

In such technology, goods to be sold are mutually transported between sellers of specialty products and other goods, thereby effectively utilizing transportation back and forth between the sellers and eliminating unnecessary movement of unloaded goods to reduce logistics costs. However, since this assumes that both parties have the goods to be transported, it cannot be applied to transportation in which the seller (sender) and purchaser (recipient) are determined for each transaction as in general e-commerce transactions.

In the system in JP 6476232 B above, a plurality of possible routes are present between the current location of the delivery requester and the delivery destination, and thus a problem occurs in that the routes cannot be sectioned into a plurality of sections in accordance with a plurality of deliverers.

Therefore, there is a need to build an AI-based system that takes on the act of moving a package on behalf of the client and delivers it to the recipient, which may be the same as a number of sites but with added responsibility and compensation thereto.

It could therefore be helpful to provide a delivery management assist system, delivery management assist method, and delivery management assist program that can assist delivery management of goods in which a plurality of deliverers deliver goods by enabling selection of an appropriate deliverer from among a plurality of deliverers in a situation where the deliverer information is not known including a sectional route of which a plurality of deliverers from among the deliverers can be in charge, the deliverer in charge of the sectional route, and the delivery fee and delivery time of the deliverer in charge of the sectional route.

### SUMMARY

We thus provide a delivery management assist system including: a receiver the receives: package information including destination, contents, weight, desired delivery amount of cost, and desired delivery time for delivery of a package requested by a delivery requester, and deliverer information including a plurality of deliverers capable of delivering the package, a sectional route that each of the deliverers is capable of being in charge of delivery, a deliverer in charge of the sectional route, and delivery fee and delivery time of the deliverer in charge of the sectional route; a sectional route generator that generates a plurality of sectional routes by sectioning a route between a current location of the delivery requester and the destination in accordance with the deliverers; a sectional route combining unit that combines two or more of the sectional routes; a deliverer selector that selects a deliverer in charge of delivery of each of the combined sectional routes from among the deliverers on the basis of the package information and the deliverer information to generate delivery charge information; and a transmitter that transmits the delivery charge information to the delivery requester.

The deliverer selector may generate delivery charge information including the deliverer in charge of delivery of each of the sectional routes and an amount of cost and time needed for delivery of the package by the deliverer in charge of delivery of each of the sectional routes.

The deliverer selector may select a deliverer in accordance with the sectional route on the basis of desired delivery amount of cost or desired delivery time from the package information.

The deliverer selector may use artificial intelligence AI to select a deliverer in charge of delivery of each of the sectional routes from among a plurality of deliverers on the basis of the package information and the deliverer information through matching by natural language processing to generate delivery charge information.

The sectional route generator may set a threshold value for a distance or time of each of the sectional routes.

The deliverer selector may select a deliverer in charge of delivery of each of the combined sectional routes from among the deliverers by weighting process on the basis of the package information and the deliverer information.

The system may further include: an approval acquisition unit that acquires ap-proval information from the delivery requester to approve the delivery charge information; and a request unit that requests a delivery operation to the deliverer in charge of delivery of each of the sectional routes in accordance with the delivery charge information.

Each of the deliverers may have an accumulated evaluation value for delivery actions by another delivery requester, and the deliverer selector may select a deliverer with a higher evaluation value in preference to a deliverer with a lower evaluation value.

The system may further include a change receiver that receives a change of the sectional route included in the delivery charge information and a change of the deliverer in the sectional route from the delivery requester. The deliverer selector may generate the delivery charge information again on the basis of the changes.

We also provide a delivery management assist method characterized by causing a computer to perform the steps of: receiving: package information including destination, contents, weight, desired delivery amount of cost, and desired delivery time for delivery of a package requested by a delivery requester, and deliverer information including a plurality of deliverers capable of delivering the package, a sectional route that each of the deliverers is capable of being in charge of delivery, a deliverer in charge of the sectional route, and delivery fee and delivery time of the deliverer in charge of the sectional route; generating a plurality of sectional routes by sectioning a route between a current location of the delivery requester and the destination in accordance with the deliverers; combining two or more of the sectional routes generated in the sectional route generating step; selecting a deliverer in charge of delivery of each of the sectional routes from among the deliverers on the basis of the package information and the deliverer information to generate delivery charge information; and transmitting the delivery charge information to the delivery requester.

We further provide a delivery management assist program characterized by causing a computer to embody the functions of: receiving: package information including destination, contents, weight, desired delivery amount of cost, and desired delivery time for delivery of a package requested by a delivery requester, and deliverer information including a plurality of deliverers capable of delivering the package, a sectional route that each of the deliverers is capable of being in charge of delivery, a deliverer in charge of the sectional route, and delivery fee and delivery time of the deliverer in charge of the sectional route; generating a plurality of sectional routes by sectioning a route between a current location of the delivery requester and the destination in accordance with the deliverers; combining two or more of the sectional routes generated by the sectional route generating function; selecting a deliverer in charge of delivery of each of the sectional routes from among the deliverers on the basis of the package information and the deliverer information to generate delivery charge information; and transmitting the delivery charge information to the delivery requester.

Our delivery management assist system includes: a receiver the receives: package information including destination, contents, weight, desired delivery amount of fee, and desired delivery time for delivery of a package requested by a delivery requester, and deliverer information including a plurality of deliverers capable of delivering the package, a sectional route that each of the deliverers is capable of being in charge of delivery, a deliverer in charge of the sectional route, and delivery fee and delivery time of the deliverer in charge of the sectional route; a sectional route generator that generates a plurality of sectional routes by sectioning a route between a current location of the delivery requester and the destination in accordance with the deliverers; a sectional route combining unit that combines two or more of the sectional routes; a deliverer selector that selects a deliverer in charge of delivery of each of the combined sectional routes from among the deliverers on the basis of the package information and the deliverer information to generate delivery charge information; and a transmitter that transmits the delivery charge information to the delivery requester. This can assist in managing the delivery of goods where a appropriate deliverer is selected for each section from among a plurality of deliverers and the deliverers deliver goods.

### BRIEF DESCRIPTION OF THE DRAWINGS

Features, advantages, and technical and industrial significance of representative examples will be described below with reference to the accompanying drawings, in which like numerals denote like elements.

FIG. 1 is a diagram illustrating a flow of packages in a delivery management assist system according to an example.

FIG. 2 is a diagram illustrating the entire delivery management assist system according to an example.

FIG. 3 is a block diagram illustrating an example configuration of a server according to an example.

FIG. 4 is a diagram illustrating an input screen on a sender terminal according to an example.

FIGS. 5A to 5D are diagrams each illustrating a table that a storage stores according to an example of the present disclosure where FIG. 5A is a table that stores sender information, FIG. 5B is a table that stores package information, FIG. 5C is a table that stores deliverer information, and FIG. 5D is a table that stores sectional route information.

FIG. 6 is a diagram illustrating a screen outputting the delivery charge information transmitted from a transmitter according to an example.

FIG. 7 is a sequence diagram illustrating an exchange among the sender terminal, the server, and a deliverer terminal according to an example.

FIG. 8 is a first flowchart illustrating a delivery management assist method according to an example.

FIG. 9 is a second flowchart illustrating a delivery management assist method according to an example.

### DESCRIPTION OF THE REFERENCE NUMERALS

1: sender
2: delivery management assist system
3: deliverer
4: recipient
20: server
30: sender terminal
40: deliverer terminal
50: recipient terminal
60: network
100: receiver
110: storage
111: sender database
112: package information database
113: deliverer database
114: sectional route information database
120: processor
121: sectional route generator
122: sectional route combining unit
123: deliverer selector
130: transmitter
140: approval acquisition unit
150: request unit
160: change receiver

### DETAILED DESCRIPTION

### Delivery Management Assist System

With reference to the drawings, a delivery management assist system according to examples will be described in detail below.

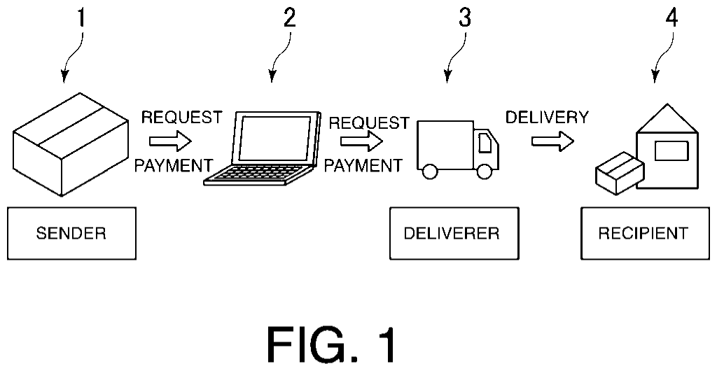

FIG. 1 is a diagram illustrating a flow of goods being delivered from a sender 1 through a plurality of deliverers 3 to a recipient 4 in a delivery management assist system 2. The delivery management assist system 2 is directed to a system that manages the delivery of goods from the sender 1 through the deliverers 3 to the recipient 4. The delivery management assist system 2 may also be directed to a system that manages the delivery of goods to the recipient 4 at the request of a company, store, individual, or delivery company. In addition, the delivery management assist system 2 may select a suitable deliverer to deliver the goods from a plurality of deliverers 3. A suitable deliverer for delivering goods is selected from among the deliverers 3 as described above, thereby facilitating the delivery of goods and effectively utilizing business trucks, for example.

When a purchaser (recipient 4) orders a certain product, a request to deliver the product is first transmitted from the sender 1 to the delivery management assist system 2. The delivery management assist system 2 accepts the delivery destination, contents, weight, desired delivery amount of costs, and desired delivery time of a package from the delivery requester (sender 1) as package information. The delivery management assist system 2 also accepts information from the deliverers 3 capable of delivering the package. The delivery management assist system 2 selects one or more suitable deliverers for delivering the package from the accepted information of the deliverers 3. The product is delivered from the sender 1 to one or more selected deliverers 3 and finally to the home of the purchaser, or the recipient 4. The deliverers 3 may correspond to individuals or companies, e.g., delivery services or food delivery companies. The means of delivery may correspond to, for example, a railroad such as the Shinkansen bullet train or a conventional train, a vehicle such as an empty truck or cab of a business, a ship, or an aircraft.

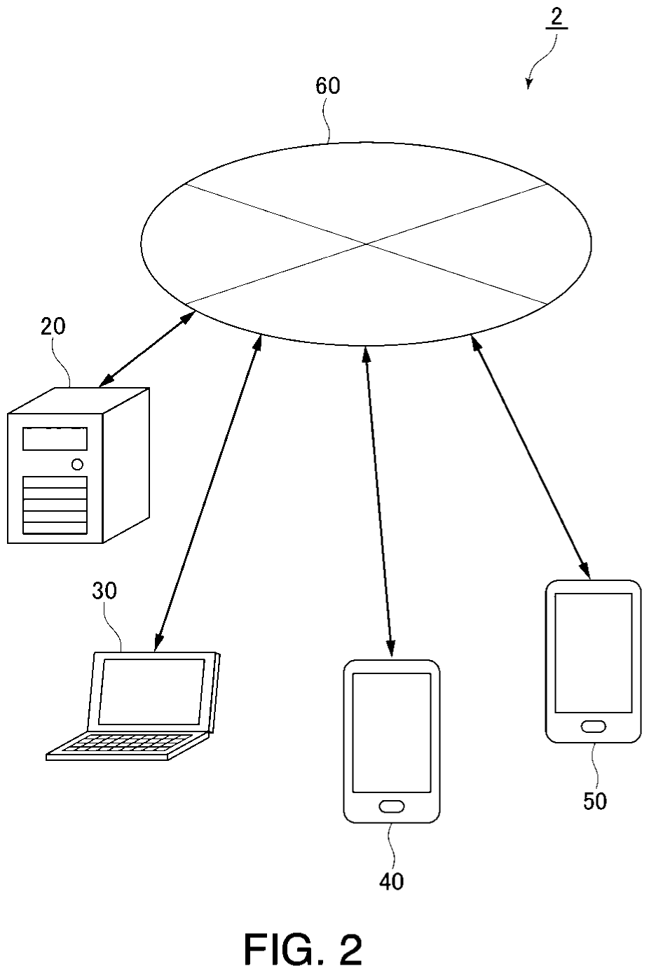

Next, with reference to FIG. 2, the overall image of the delivery management assist system 2 will be described. The delivery management assist system 2 includes a server 20, a sender terminal 30, a deliverer terminal 40, and a recipient terminal 50, which are connected via a network 60. The sender 1 transmits package information through the sender terminal 30 to the server 20, and the deliverer 3 transmits the deliverer information through the deliverer terminal 40 to the server 20. The server 20 selects one or more deliverers from among the deliverers 3 on the basis of the package information received from the sender terminal 30 and the deliverer information received from the deliverer terminal 40. The server 20 transmits the information on the selected deliverers to the sender terminal 30 and the recipient terminal 50. The sender terminal 30, the deliverer terminal 40, and the recipient terminal 50 may be configured by general-purpose infor-mation processing terminals such as smartphones, tablet terminals, and personal computers PCs, for example, access the delivery management assist system 2 using a web browser or dedicated application (not shown in the drawings), and display a screen to the user.

The sender 1 corresponds to a user that sends the package to be delivered, and the recipient 4 corresponds to a user that receives it. The deliverer 3 corresponds to a user that has offered to deliver at least a part of the section to be delivered as being available for delivery.

The server 20 is directed to a server system that provides logistics assist services by performing matching (matching coordination) between the sender 1 and the deliverer 3 for package delivery from the sender 1 to the recipient 4 as well as managing the status of relay-style deliveries performed on the basis of the matching results. That is, the route for delivery is configured by a combination of sections and deliverers one after another: this deliverer for one section, that deliverer for the next section, and a further deliverer for the further next section, for example. For example, the server 20 is configured by a server device or a virtual server built on a cloud computing service, and a central processing unit (not shown in the drawings) executes middleware such as an operating system OS, database management system DBMS, and Web server programs that are developed in memory from the storage devices such as a hard disk drive HDD, and software running on them to embody the various functions described below to provide logistics assist services.

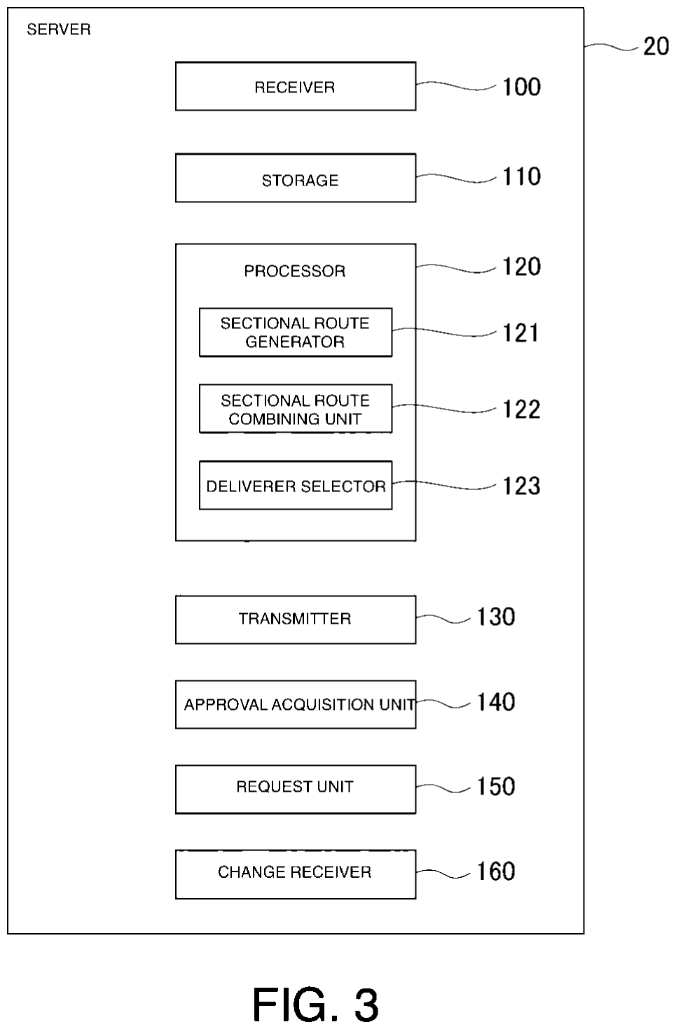

Next, with reference to FIG. 3, the functions of the server 20 will be described. The server 20 includes a receiver 100, a storage 110, a processor 120, a transmitter 130, an approval acquisition unit 140, a request unit 150, and a change receiver 160.

The receiver 100 accepts the sender and the information on her/him, specifically, the destination, contents, weight, desired delivery amount of costs, and desired delivery time of the package requested to be delivered by the sender (sender 1) as package information. The delivery destination of the package corresponds to the recipient 4 described above as all the users that have requested the sender 1 to deliver the package. The contents of the package range from large to small items, including large items such as sand bags, flour, and molds; furniture such as beds, couches, desks, and chairs; bedding such as futon mats and pillows; electrical appliances such as TVs, radios, computers, and printers; white goods such as refrigerators and washing machines; and small items such as books, CDs, and DVDs. The weight of the package varies widely: 500 g to 1 kg for small items such as books, CDs, and DVDs; 2 to 3 kg for bedding such as futon mats and pillows; 5 to 10 kg for electrical appliances such as TVs, radios, computers, and printers; 10 to 20 kg for furniture such as beds, couches, desks, and chairs; 20 kg for sand bags, 25 kg for flour, 30 to 40 kg for white goods such as refrigerators, and washing machines; and 50 to 60 kg for molds, for example. The desired delivery amount of costs may be, for example, free, 100 yen, 500 yen, or 1,000 yen. The desired delivery time may be, for example, 1 hour, 12 hours, 1 day, or 2 days from shipping.

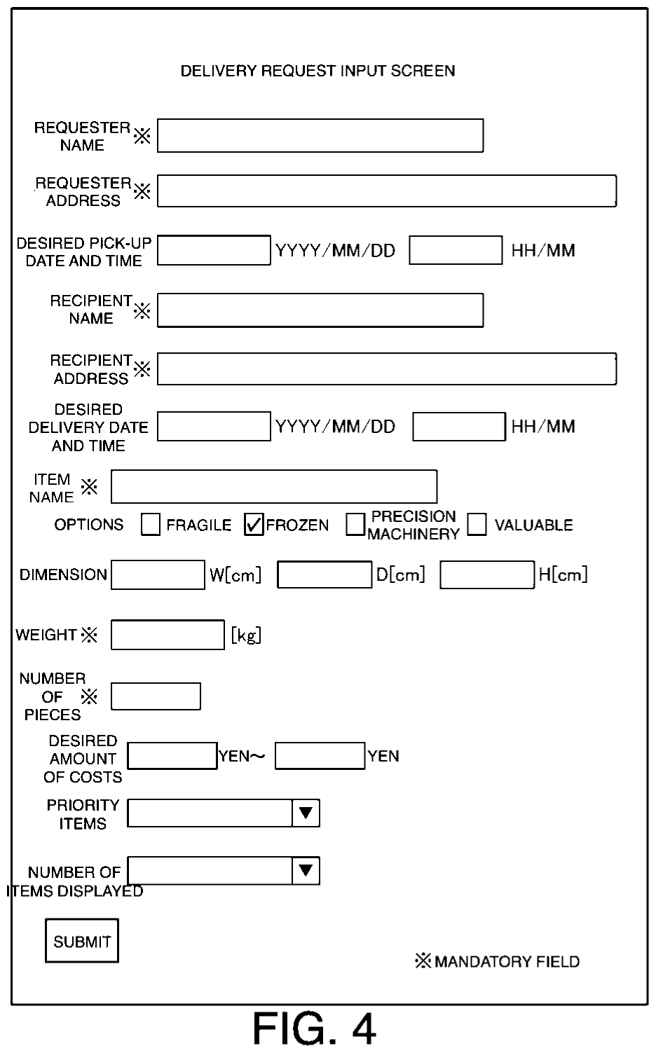

FIG. 4 shows a delivery request input screen from the sender 1, which is accepted by the receiver 100. The sender 1 enters her/his name as the requester name, her/his address as the requester address, and the date and time she/he wishes the shipment picked up through the screen. The sender 1 also enters the name of the recipient 4 in the recipient name field, the address of the recipient 4 in the recipient address field, and the date and time she/he wishes the delivery. The sender 1 also enters the name of the package in the item name field and optionally checks “Fragile,” “Frozen,” “Precision Machinery,” and “Valuable” if applicable. The sender 1 also enters the dimension of the package as width (W [cm]), depth (D [cm]) and height (H [cm]). The sender 1 also enters the weight of the package in “kg,” the number of pieces, and the desired delivery amount of costs in “XX yen to XX yen.” The sender 1 may also select from a pull-down menu for priority items and number of items to be displayed. For example, the priority items may include items such as “prioritize cheapness” or “prioritize speed,” and the number of items to be displayed may include items such as “5” or “10,” allowing the user to select suitable items among those items. Finally, clicking the “Submit” button allows the information entered above to be accepted.

The receiver 100 also accepts deliverers, i.e., a plurality of deliverer 3 capable of delivering packages. Specifically, the deliverers 3 may correspond to individuals or companies, e.g., delivery services or food delivery companies. The means of delivery may correspond to, for example, a railroad such as the Shinkansen bullet train or a conventional train, a vehicle such as an empty truck or cab of a business, a ship, or an aircraft.

The receiver 100 also accepts deliverers and the information on them, that is, it accepts from each of the deliverers 3, as deliverer information, the sectional routes that can be handled by the deliverers 3, the deliverers in charge of the sectional routes, and the delivery costs and delivery times of the deliverers in charge of the sectional routes. Specifically, for example, in the railroad example above, it is assumed that the first deliverer may be in charge of the first sectional route from Ueno Station to Tokyo Station, the second deliverer may be in charge of the second sectional route from Tokyo Station to Shin-Osaka Station, and the third deliverer may be in charge of the third sectional route from Shin-Osaka Station to Kobe Station, and the delivery fee for the first deliverer may be 100 yen, the delivery fee for the second deliverer may be 1,000 yen, and the delivery fee for the third deliverer may be 200 yen. Further, the delivery time for the first deliverer may be 1 hour, for the second deliverer 2 hours and 30 minutes, and for the third deliverer 20 minutes. Moreover, in the vehicle example above, it is assumed that the first deliverer may be in charge of the first sectional route from the X interchange to the Y junction, the second deliverer may be in charge of the second sectional route from the Y junction to the Z interchange, and the third deliverer may be in charge of the third sectional route from the Z interchange to the W junction, the delivery cost for the first deliverer may be 100 yen, the delivery cost for the second deliverer may be 200 yen, and the delivery cost for the third deliverer may be 150 yen, and the delivery time for the first deliverer may be 30 minutes, the delivery time for the second deliverer may be 40 minutes, and the delivery time for the third deliverer may be 20 minutes.

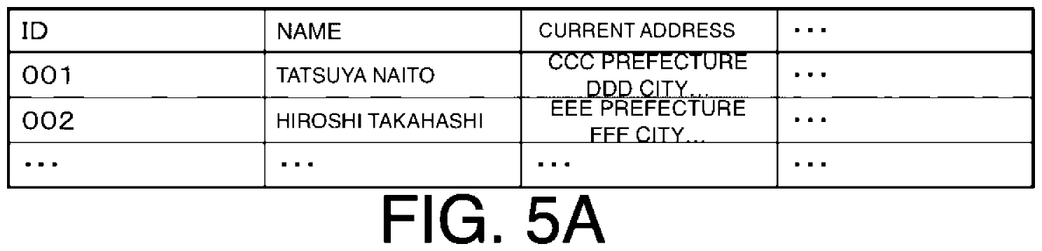

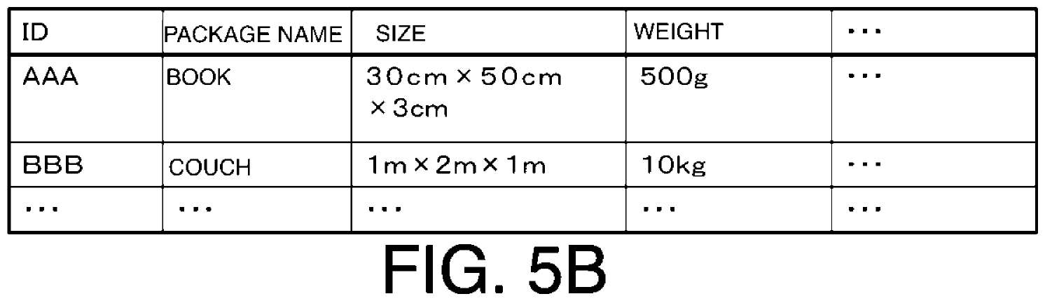

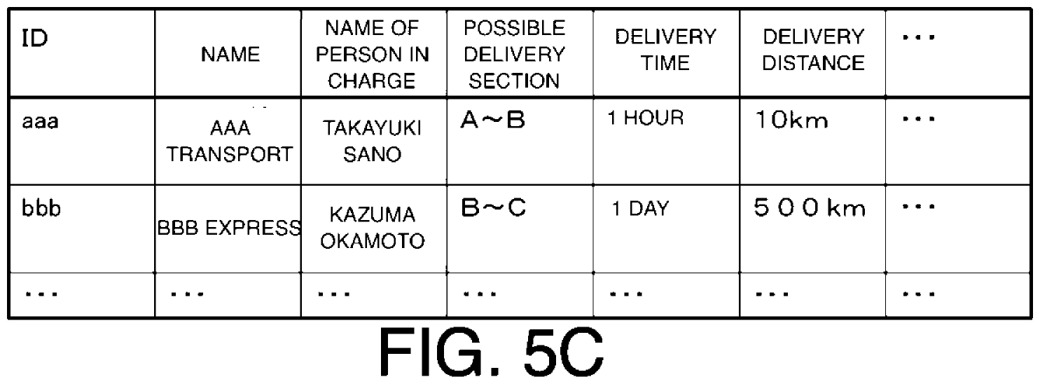

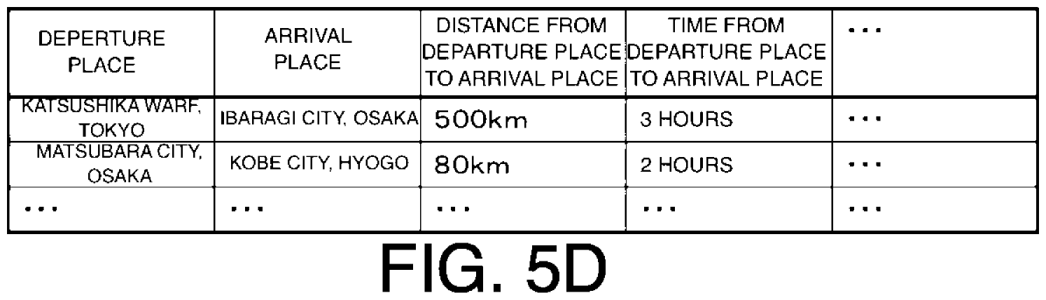

The information received by the receiver 100 is stored in the storage 110. The storage 110 stores information, specifically, as shown in FIGS. 5A to 5D, it stores a sender information database 111, a package information database 112, a deliverer information database 113, and a sectional route information database 114. The sender information database 111 stores a table associating the ID with the name, and current address of the sender 1, for example (see FIG. 5A), the package information database 112 stores a table associating the ID with the contents, size, and weight of the package, for example (see FIG. 5B), the deliverer information database 113 stores a table associating the ID with the name, name of the person in charge, possible delivery sections, delivery fees and delivery time of the deliverer (see FIG. 5C), and the sectional route information database 114 stores a table associating the place of departure, place of arrival, distance from the place of departure to the place of arrival, and time from the place of departure to the place of arrival with each other, for example (see FIG. 5D).

The processor 120 includes a sectional route generator 121, a sectional route combining unit 122, and a deliverer selector 123.

The sectional route generator 121 generates a plurality of candidate sectional routes for the route from the current location of the delivery requester (sender 1) to the delivery destination (recipient 4), that is, the route between the current location of the delivery requester (sender 1) and the delivery destination (recipient 4) is sectioned in accordance with the deliverers 3 to generate a plurality of sectional routes. Specifically, for example, if the current location of the delivery requester (sender 1) is Ueno, Taito-Ku, Tokyo, and the delivery destination (recipient 4) is Kobe City, Hyogo Prefecture, and the delivery means is by rail, the first sectional route may be from Ueno Station to Tokyo Station, the second sectional route may be from Tokyo Station to Shin-Osaka Station, and the third sectional route may be from Shin-Osaka Station to Kobe Station. For example, if the current location of the delivery requester is Matsubara City, Osaka Prefecture, and the delivery destination is Nishi-ku, Kobe City, Hyogo Prefecture, and the delivery means is by vehicle, the route from the X interchange to the Y junction may be the first sectional route, the route from the Y junction to the Z interchange may be the second sectional route, and the route from the Z interchange to the W junction may be the third sectional route.

In addition, the sectional route generator 121 sets a threshold value for the distance or time for each of the sectional routes. The sectional route generator 121 acquires the above sectional route as numerical information of distance and time. The sectional route generator 121 may set the numerical information above to a predetermined threshold value for the reference distance or reference time, for example, the reference distance of the route may be set to 1 km, and used that as the threshold value, and in the delivery of the route with the distance exceeding the threshold value, AAA Transport may be selected as the deliverer. For example, the reference delivery time may be set to one day, and used that as the threshold value, and in the delivery of the route with the delivery time exceeding the threshold value, YYY Express may be selected as the deliverer.

The sectional route combining unit 122 combines a plurality of candidate sectional routes generated by the sectional route generator 121 for the route from the current location of the delivery requester (sender 1) to the delivery destination (recipient 4), that is, it combines the sectional routes between the current location of the delivery requester (sender 1) and the delivery destination (recipient 4) with the deliverers 3. As described above, for the sectional routes that have been divided into smaller segments of a certain section, it is determined what combination of the sectional routes is desired in consideration of the factors including the threshold value, and the sectional routes are combined. For example, if the sectional route from point P to point Q is “α1, α2, α3, α4” and the sectional route from point Q to point R is “β1, β2, β3,” α2 is selected for the sectional route from point P to point Q and β1 is selected for the sectional route from point Q to point R, and the sectional routes “α2” and “β1” are connected. Specifically, for example, if the current location of the delivery requester (sender 1) is Ueno, Taito-ku, Tokyo, the delivery destination (recipient 4) is Kobe City, Hyogo Prefecture, the delivery means is by rail, and the sectional route generator 121 generates a first sectional route from Ueno Station to Tokyo Station, a second sectional route from Tokyo Station to Shin-Osaka Station, and a third sectional route from Shin-Osaka Station to Kobe Station, these first, second, and third sectional routes can be combined. For example, if the current location of the delivery requester is Matsubara City, Osaka Prefecture, and the delivery destination is Nishi-ku, Kobe City, Hyogo Prefecture, the delivery means is by vehicle, and the sectional route generator 121 generates the sectional routes, these first through third sectional routes may be combined.

The deliverer selector 123 selects a deliverer that can actually operate, that is, it selects a deliverer in charge of the delivery of each of the sectional routes from among a plurality of deliverers on the basis of the package information and deliverer information, and generates delivery charge information.

Specifically, when the receiver 100 accepts a sender, a deliverer, and information on the sender, the deliverer selector 123 performs matching to select a deliverer suitable for delivery of the package that the sender 1 wishes her/him to deliver on the basis of the information in the sender information database 111, the package information database 112, the deliverer information database 113, and the sectional route information database 114 stored in the storage 110. As a result of the matching, for example, in the vehicle example above, AAA Transportation may be selected as the first deliverer in charge of the first sectional route from the X interchange to the Y junction, YYY Express may be selected as the second deliverer in charge of the second sectional route from the Y junction to the Z interchange, and Motorcycle Delivery Service may be selected as the third deliverer in charge of the third sectional route from the Z interchange to the W junction.

The deliverer selector 123 uses artificial intelligence AI, and through matching based on the natural language processing, selects a deliverer in charge of delivery for each of the sectional routes from among the deliverers above on the basis of the package information and the deliverer information to generate deliver charge information.

The artificial intelligence AI technology is utilized for the matching. The AI may use supervised or unsupervised learning models. The AI performs deep learning on the basis of big data such as map information and road information stored in the storage 110 to select one or more desired deliverers suitable for delivery of the package from among a plurality of deliverers. The matching is also constructed from a combination of past delivery records, current traffic conditions, the total number of deliverers, and the delivery capacity of the deliverers.

Specifically, the matching is performed using natural language processing. The natural language processing is directed to a technology that allows computers to process natural languages used by humans in everyday life, and refers to language processing from an engineering perspective. The natural language processing is directed to a process of converting information in a database into natural language or converting natural language sentences into more formal, computer-understandable expressions. The natural language processing may include morphological analysis, syntactic analysis, contextual analysis, and semantic analysis.

In this example, since only word information is stored in the sender information database 111, the package information database 112, the deliverer information database 113, and the sectional route information database 114, which are stored by the storage 110, morphological analysis and syntactic analysis cannot be performed, and thus semantic analysis is performed. The semantic analysis is one of the processing steps in the target program generation process programming language when the compiler analyzes the source code to generate the target program. This checks whether the types of variables and statements described in the source code conform to the description specifications of the language, and then the target delivery management assist program described below is created through code generation and control procedures.

The matching performed using the natural language processing will be illustrated as follows. For example, on the side of the sender, the matching may be performed to register the sender, i.e., to verify her/his identity. The semantic analysis above is performed on the basis of the word information such as the name and current address of the sender. This semantic analysis generates and controls the code of the sender.

For example, this may be performed for a cashless application. For example, the semantic analysis above is performed on the basis of the credit card information and the word information of the bank account of the sender. This semantic analysis generates and controls the code of the sender.

For example, this may be performed for registration of the moving date and time. For example, the above semantic analysis is performed on the basis of the word information of the date and time of the move of the deliverer (e.g., Apr. 1, 2021, 6:00 p.m. to Apr. 2, 2021, 12:00 p.m.) that the sender wishes the package to be delivered. This semantic analysis generates and controls the code of the deliverer.

For example, this may be performed for pick-up location registration. For example, the semantic analysis above is performed on the basis of the word information of a place where the deliverer picks up the package from the sender (e.g., Katsushika-ku, Tokyo). This semantic analysis generates and controls the code of the deliverer.

For example, this may be performed for destination direction registration. For example, the semantic analysis above is performed on the basis of the word information of the direction in which the deliverer transports the package toward the recipient (e.g., Kansai direction). This semantic analysis generates and controls the code of the deliverer.

For example, this may be performed for load registration. For example, the semantic analysis is performed on the basis of the word information of the load (e.g., 10 kg, 1 ton, for example) that the deliverer loads into the vehicle when transporting the package toward the recipient. This semantic analysis generates and controls the code of the deliverer.

For example, this may be performed for matching searches. For example, the semantic analysis above is performed on the basis of the word information of the desired conditions of the sender, deliverer, and recipient (e.g., 10 km, 1 day, person in Kanto region, and person in Kansai region, for example). This semantic analysis generates and controls the code of the deliverer.

For example, this may be performed for commission in an application. For example, since the information when the sender consigns the delivery of a package to a deliverer using an application in a terminal in which the system according to this example is installed (e.g., information in which the sender wishes the package to be delivered at 16:00 on Apr. 2, 2021, to a person living in the Kansai region 500 km away for 500 yen over one day) corresponds to a sentence, morphological analysis and/or syntactic analysis is performed on the basis of the sentence. The morphological and/or syntactic analysis generates and controls the code of the deliverer.

For example, this may be performed for the pick-up of the goods. For example, the semantic analysis above is performed on the basis of the word information such as the name, type, size, weight, and quantity of the goods that the sender wishes the deliverer to pick up (e.g., bed, furniture, 1 m×2 m×1 m, 10 kg, and 1 person, for example). This semantic analysis generates and controls the code of the product.

For example, this may be performed to confirm completion. For example, the semantic analysis above is performed on the basis of the word information that the delivery of the package has been completed by the deliverer to the recipient (e.g., Apr. 2, 2021, 16:00, a person in the Kansai region). This semantic analysis generates and controls the code of the deliverer.

For example, this may be performed for service fee payments. For example, the semantic analysis above is performed on the basis of the word information of the service fee paid by the sender to the deliverer (e.g., 1,000 yen). This semantic analysis generates and controls the code of the deliverer.

The date and time of the receipt of the package from the delivery person to the recipient and the signature of the recipient may be confirmed on the app.

For example, on the system side, this may be performed to register a freight forwarding business. For example, the semantic analysis above is performed on the basis of the word information (e.g., company name, address, telephone, representative name, and business description, for example) corresponding to the registration information for the freight forwarding business by the deliverer using the system according to this example. This semantic analysis generates and controls the code of the sender.

For example, this may be performed to register a travel agency. For example, the semantic analysis above is performed on the basis of the word information (e.g., company name, address, telephone, representative name, and business description, for example) as the registration information for a deliverer using the system according to this example to conduct travel business. This semantic analysis generates and controls the code of the sender.

For example, this may be performed to operate an application. For example, the semantic analysis above is performed on the basis of the word information (e.g., company name, address, telephone, representative name, and business description, for example) as the registration information for the deliverer using the system according to this example to operate the application. This semantic analysis generates and controls the code of the sender.

For example, this may be performed for committing information from a client. For example, the semantic analysis above is performed on the basis of the word information (e.g., bed, furniture, 1 m×2 m×1 m, 10 kg, and 1 piece, for example) of a package that is entrusted by a delivery requester to a deliverer using the system. This semantic analysis generates and controls the code of the package.

For example, this may be performed to transmit information to the delivery person. For example, the semantic analysis above is performed on the basis of the word information of a package (e.g., bed, furniture, 1 m×2 m×1 m, 10 kg, 1 piece, for example) that the deliverer using the system according to this example allows the delivery person to deliver. This semantic analysis generates and controls the code of the package.

For example, this may be performed to make a post-completion payment to the delivery person. For example, the semantic analysis above is performed on the basis of the word information of the amount of money (e.g., 100 yen, 1,000 yen, and 10,000 yen, for example) that the deliverer using the system according to this example pays to the delivery person. This semantic analysis generates and controls the code of the package.

For example, this may be performed for post-completion settlement to the client. For example, the semantic analysis above is performed on the basis of the word information as information that the deliverer using the system according to this example allows the client to settle (e.g., the credit card number or bank account number of the sender). This semantic analysis generates and controls the code of the package.

For example, this may be performed for safety verification. For example, since the information on whether the sender using the system according to this example is safe (e.g., reviews from senders and recipients about past deliveries) corresponds to a sentence, morphological and/or syntactic analysis is performed. The morphological and/or syntactic analysis generates and controls the code of the deliverer.

In connection with the safety verification above, this may be performed for the introduction of a delivery person evaluation system. For example, since the information on the ability of the delivery person that the deliverer using the system according to this example allows to deliver the package (e.g., reviews from the sender and recipient about past deliveries about whether the package has been delivered on time, or whether the package has been damaged, for example) corresponds to a sentence, morphological and/or syntactic analysis is performed. The morphological and/or syntactic analysis generates and controls the code of the deliverer.

For example, these may be performed to determine an infringement of the Postal Code (in which letters are not permitted to be delivered). For example, the semantic analysis above is performed on the basis of the word information of whether the deliverer using the system according this example is in violation (e.g., in violation, or not in violation, for example) of the Postal Code (non-contravention of service of letters). This semantic analysis generates and controls the code of the package.

For example, this may be performed to confirm that the Labor Standards Act is not applicable. For example, since the information on whether the deliverer using the system according to this example is forcing the delivery person to work in violation of the Labor Standards Law (e.g., forcing the delivery person to work 24 hours straight without sleeping, without a day off for a month, for example) corresponds to a sentence, morphological and/or syntactic analysis is performed. The morphological and/or syntactic analysis generates and controls the code of the deliverer.

For example, on the side of the delivery person, this may be performed to register the delivery person, i.e., to verify her/his identity. For example, the semantic analysis above is performed on the basis of the word information of the name and current address of the delivery person. This semantic analysis generates and controls the code of the delivery person.

For example, this may be performed for sharing current location. For example, the current location of the delivery person (e.g., Katsushika-ku, Tokyo) is shared by the sender and the deliverer. The semantic analysis above is performed on the basis of this information. This semantic analysis generates and controls the code of the delivery person.

For example, this may be performed for registration of the moving date and time. For example, the semantic analysis above is performed on the basis of the word information of the date and time when the delivery person of the deliverer that the recipient wishes to deliver (e.g., Apr. 1, 2021, 18:00 to Apr. 2, 2021, 12:00). This semantic analysis generates and controls the code of the delivery person.

For example, this may be performed for destination direction registration. For example, the semantic analysis above is performed on the basis of the word information of the direction in which the delivery person transports the package toward the recipient (e.g., Kansai direction). This semantic analysis generates and controls the code of the delivery person.

For example, this may be performed for means of transport (load) registration. For example, the semantic analysis above is performed on the basis of the word information of by what the delivery person travels when transporting the package toward the recipient and the load capacity at that time (e.g., vehicle, 1 ton, for example). This semantic analysis generates and controls the code of the delivery person.

For example, this may be performed for matching searches. For example, the semantic analysis above is performed on the basis of the word information of the desired conditions of the sender, deliverer, delivery person and recipient (e.g., 10 km, 1 day, cheap deliverer, fast deliverer, person in Kanto region, and person in Kansai region, for example). This semantic analysis generates and controls the code of the delivery person.

For example, this may be performed for a commission via an application. For example, since the information provided by a delivery person when she/he accepts a pack-age delivery using an application in a terminal in which the system according to this exam-ple is installed (e.g., the sender wishes a package to be delivered at 16:00 on Apr. 2, 2021 to a person living in the Kansai region 500 km away for 500 yen over one day) corresponds to a sentence, morphological and/or syntactic analysis is performed. This morphological and/or syntactic analysis generates and controls the code of the delivery person.

For example, this may be performed for pick-up from a pick-up location. For example, the semantic analysis above is performed on the basis of the word information of the location where the delivery person picks up the package from the deliverer (e.g., Katsushika-ku, Tokyo). This semantic analysis generates and controls the code of the delivery person.

For example, this may be performed for traveling to a delivery destination. For example, the semantic analysis above is performed on the basis of the word information of places where the delivery person picks up the package from the sender and the recipient receives the package (e.g., Higashi Sumiyoshi Ward, Osaka City). This semantic analysis generates and controls the code of the delivery person.

For example, this may be performed for the delivery of goods. For example, the semantic analysis above is performed on the basis of the word information such as the item name, type, size, weight, and quantity of the package to be delivered by the delivery person to the recipient (e.g., bed, furniture, 1 m×2 m×1 m, 10 kg, and 1 person). This semantic analysis generates and controls the code of the product.

For example, this may be performed for a receipt signature (app). For example, the delivery person delivers the package to the recipient, and the recipient signs on the app that she or he has received it. The semantic analysis above is performed on the basis of the word information as this information (e.g., received, not yet received, for example). This semantic analysis generates and controls the code of receipt.

For example, this may be performed for completion communication. For example, since the information that the deliverer informs the recipient that the package has been delivered (e.g., delivery has been completed to a person in the Kansai region at 16:00 on Apr. 2, 2021) corresponds to a sentence, morphological and/or syntactic analysis is performed. This morphological and/or syntactic analysis generates and controls the code of the delivery person.

For example, this may be performed to receive a reward. For example, the semantic analysis above is performed on the basis of the word information as the information of the reward paid by the deliverer to the delivery person (e.g., 1,000 yen). This semantic analysis generates and controls the code of the delivery person.

When the delivery of the package is completed, the delivery person shall register the receipt.

For example, on the side of the recipient, this may be performed for receipt of product. For example, the semantic analysis above is performed on the basis of the information of the product received by the recipient (e.g., bed, furniture, 1 m×2 m×1 m, 10 kg, and one person, for example). This semantic analysis generates and controls the code of the product.

The deliverer selector 123 is capable of generating delivery charge information including the deliverer in charge of delivery of each of sectional routes and the amount of cost and time needed to deliver the package of the deliverer in charge of delivery of each of the sectional routes.

The deliverer selector 123 is capable of selecting a deliverer in accordance with the sectional route on the basis of the desired delivery amount of cost or desired delivery time from the package information.

The deliverer selector 123 weights the deliverer in charge of the delivery of each of the combined sectional routes from among a plurality of deliverers on the basis of the package and deliverer information. For the weighting performed by the deliverer selector 123, from the weight, quantity, desired delivery time, or delivery distance of the package in the package information, and the available delivery area, delivery distance, estimated delivery time, or available delivery person of the deliverer in the deliverer information, for example, the factors of the desired delivery time from the package information and the estimated delivery time from the deliverer information are overweighted (weighted more heavily).

For example, the deliverer selector 123 may, if the residence of the recipient 4 is less than 10 km from the current location of the sender 1, apply the delivery cost preferentially and the deliverer with lower delivery cost may be applied more preferentially than the deliverer with higher delivery cost, and if the residence of the recipient 4 is greater than or equal to 10 km from the current location of the sender 1, apply the delivery time preferentially and the deliverer with shorter delivery time may be applied more preferentially than the deliverer with longer delivery time. In addition, in the deliverer selection function, evaluation values for delivery actions may be accumulated on each of the multiple deliverers by other delivery requesters, and the deliverer selection function may select the deliverer with the higher evaluation value in preference to the deliverer with the lower evaluation value.

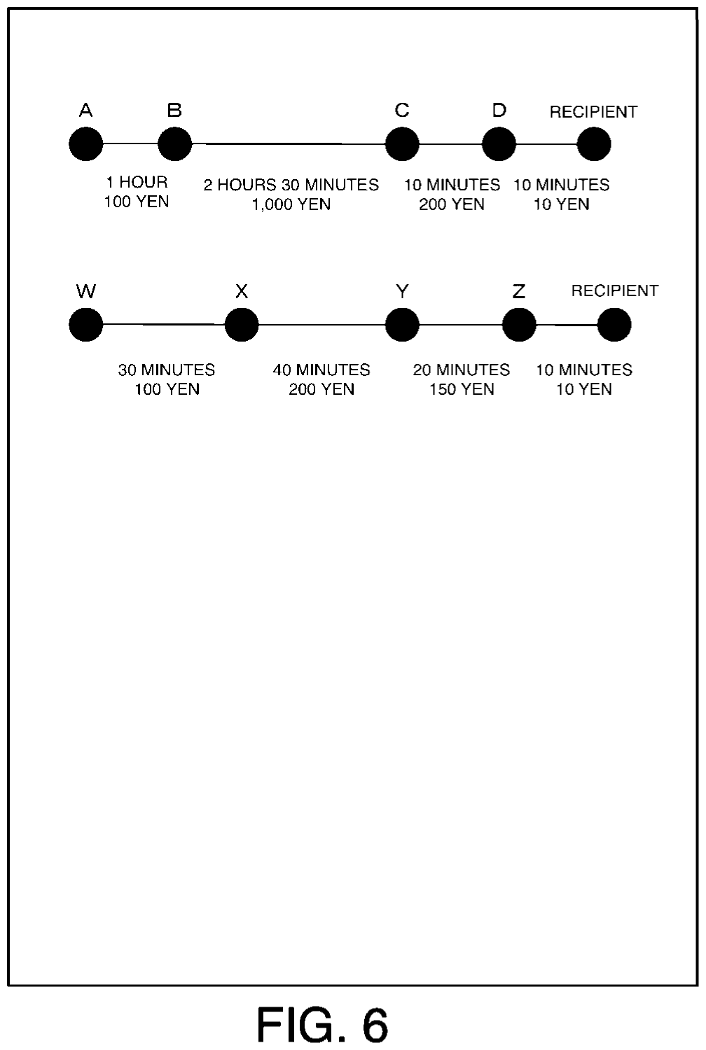

The transmitter 130 transmits information to the delivery requester (sender 1), that is, it transmits to the delivery requester (sender 1) the delivery charge information selected by the deliverer selector 123. Specifically, the delivery requester (sender 1) is allowed by her/his terminal 30 to know the information such that, as shown in FIG. 6, for example, in the railroad example above, as shown in the upper row, the delivery from point A to point B is 100 yen for 1 hour, from point B to point C is 1,000 yen for 2 hours and 30 minutes, from point C to point D is 200 yen for 10 minutes, and from point D to the recipient 4 is 10 yen for 10 minutes, and, for example, in the vehicle example above, as shown in the lower row, the first deliverer in charge of the first sectional route from point W to point X is AAA Transport and the delivery charges 100 yen for 30 minutes, the second deliverer in charge of the second sectional route from point X to point Y is BBB Express and the delivery charges 200 yen for 40 minutes, the third deliverer in charge of the third sectional route from point Y to point Z is Motorcycle Delivery Service, and the delivery charges 150 yen for 20 minutes since the information is displayed on the user interface of the terminal.

The approval acquisition unit 140 acquires approval from the delivery requester (sender 1), that is, it acquires approval information from the delivery requester (sender 1) to approve the delivery charge information. Specifically, the delivery requester (sender 1) approves the delivery charge information received from the transmitter 130 if there are no problems. The approval acquisition unit 140 acquires approval information approved by the delivery requester (sender 1). For example, in the vehicle example above, the approval acquisition unit 140 acquires the information in which the delivery such that the first deliverer in charge of the first sectional route from the X interchange to the Y junction is AAA Transport, the second deliverer in charge of the second sectional route from the Y junction to the Z interchange is BBB Express, and the third deliverer in charge of the third sectional route from the Z interchange to the W junction is Motorcycle Delivery Service has been approved. The delivery charge information is finalized by approval as described above.

The request unit 150 requests delivery operations to the deliverer, that is, it requests delivery operations to the deliverer in charge of the delivery of each of the sectional routes in accordance with the delivery charge information determined by the approval from the delivery requester (sender 1). Specifically, for example, in the vehicle example above, AAA Transportation as the first deliverer is requested to deliver a package from the X interchange to the Y junction as the first sectional route, BBB Express as the second deliverer is requested to deliver from the Y junction to the Z interchange as the second sectional route, and Motorcycle Delivery Service as the third deliverer is requested to deliver from the Z interchange to the W junction as the third sectional route.

Evaluation values for delivery actions are accumulated on each of the multiple deliverers 3 by other delivery requesters (senders 1), and the deliverer selector 123 selects the deliverer with the higher evaluation value in preference to the deliverer with the lower evaluation value. For example, the rating value may be a 10-grade evaluation from 1 to 10. For example, in the example above, if the evaluation value of AAA Transportation is five for Mr. A, six for Mr. B, and four for Mr. C, the average value will be five; if the evaluation value of BBB Express is three for Mr. A, five for Mr. B, and four for Mr. C, the average value will be four; if the evaluation value of Motorcycle Delivery Service is two for Mr. A, four for Mr. B, and three for Mr. C, the average value will be three. That is, AAA Transportation with the highest average value of evaluation will be selected in preference to BBB Express and the Motorcycle Delivery Service.

The change receiver 160 receives changes from the delivery requester (sender 1), that is, it receives a change of the sectional route included in the delivery charge information from the delivery requester (sender 1), and a change of the deliverer 3 in that sectional route. Specifically, for example, in the vehicle example above, the first sectional route has been from the X interchange to the Y junction, but if the delivery requester (sender 1) requests that this be changed to a route from the X interchange to the Y′ junction, the change receiver 160 receives the change of the first sectional route to the route from the X interchange to the Y′ junction. The change receiver 160 can also receive a change request to switch the deliverer 3 in charge of the first sectional route from AAA Transportation to BBB Express. In addition, since the first sectional route has been changed to the route from the X interchange to the Y′ junction, the starting point of the second sectional route is changed to the Y′ junction, and the second sectional route is changed to the route from the Y′ junction to the Z interchange as well. In this example, if the delivery requester (sender 1) requests that Motorcycle Delivery Service is preferable for the route from the Y′ junction to the Z interchange, then the deliverer 3 delivering the second sectional route is changed to Motorcycle Delivery Service.

The deliverer selector 123 generates delivery charge information again on the basis of these changes from the delivery requester (sender 1). The delivery charge information is then transmitted again to the delivery requester (sender 1) and awaits approval from the delivery requester (sender 1).

### Flow of Delivery

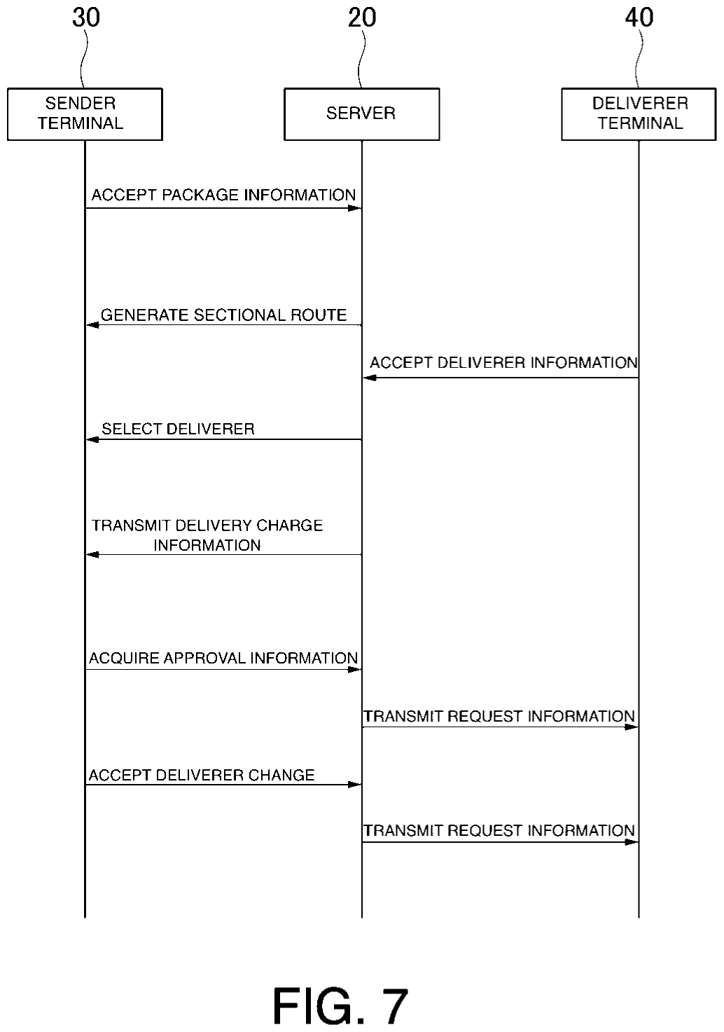

Next, with reference to FIG. 7, the flow of package delivery by the delivery management assist system 2 will be described.

FIG. 7 shows a sequence diagram of the exchange among the sender terminal 30, the server 20, and the deliverer terminal 40. The server 20 accepts package information from the sender terminal 30 and the deliverer 3 from the deliverer terminal 40. The server 20 generates a sectional route and transmits it to the sender terminal 30. The server 20 accepts deliverer information from the deliverer terminal 40. The server 20 selects the deliverer 3 and transmits the delivery charge information to the sender terminal 30. The server 20 acquires approval information from the sender terminal 30. The server 20 accepts the change of the deliverer from the sender terminal 30. After the server 20 accepts the change of the deliverer, it again executes the process described above from the generation of the sectional route onward. The server 20 also transmits request information to the deliverer terminal 40 of the deliverer that is in charge of delivery of each of the sectional routes in accordance with the delivery charge information to request delivery operations. The transmission of the request information is executed after acquiring the approval information.

With the delivery management assist system according to this example, delivery persons throughout the country can install application software on smartphones and tablet terminals, for example, and the sender can register package information and select desired conditions using AI independent of the delivery method so that the truck sharing can be supported. A separate payment service upon completion of the transportation operation is linked and activated to allow payment of delivery costs on the terminal. For example, if a client wishes to deliver a piece of cardboard from Osaka to Nagoya, the cardboard may be delivered to Nagoya if a delivery person that goes to Tokyo by car is present. Further, when documents to be delivered daily from Ibaraki to the head office in Shibuya are present, if a deliverer whose place of work is Shibuya is present, she/he can deliver the documents to Shibuya on the way to Shibuya. This dispels the stereotype of requesting a deliverer to deliver packages and allows any means to deliver the packages.

### Delivery Management Assist Method and Delivery Management Assist Program

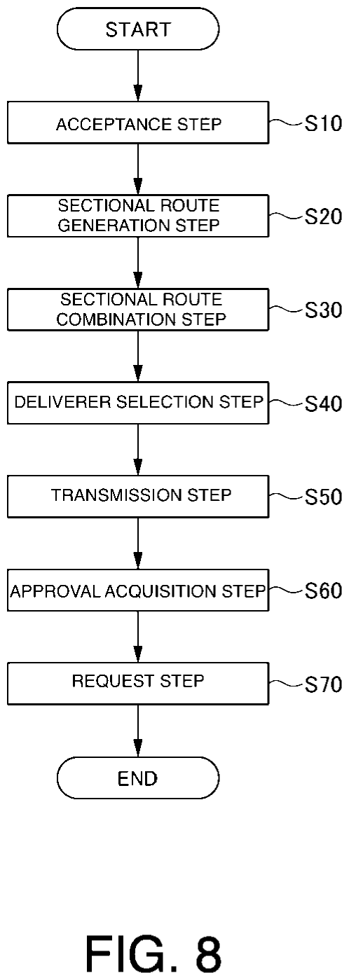

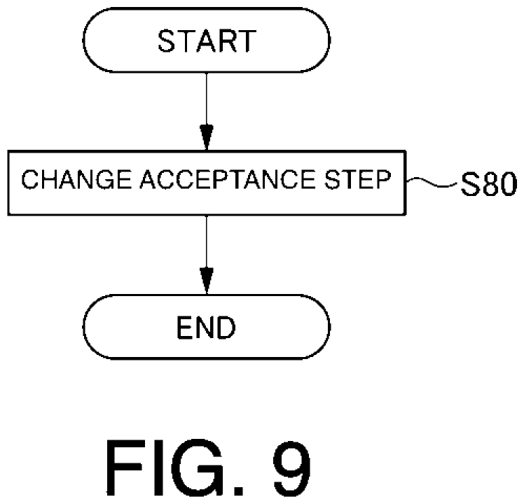

Next, with reference to FIGS. 8 and 9, the delivery management assist method as well as the delivery management assist program will be described. The delivery management assist method is executed by the CPU of a processor 120 on the basis of the delivery management assist program. The delivery management assist program causes the processor 120 to perform the following functions: reception function, sectional route generation function, sectional route combination function, deliverer selection function, transmission function as well as approval acquisition function and request function. The functions are performed in the order shown in FIGS. 8 and 9. Since the description of the functions is redundant with the description of the delivery management assist system 2 above, the details thereof will be omitted.

From the flowchart in FIG. 8, the processor 120 includes the following steps: acceptance step (step S10), sectional route generation step (step S20), sectional route combination step (step S30), deliverer selection step (step S40), transmission step (step S50), approval acquisition step (step S60), and request step (step S70). It also includes a change acceptance step (step S80) from the flowchart in FIG. 9. The various steps needed for the operation of the processor 120 itself are naturally included.

The acceptance function accepts package information including the destination, contents, weight, desired delivery amount of cost, and desired delivery time of the delivery requested by the delivery requester, and the deliverer information including a plurality of deliverers capable of delivering the package, the sectional routes that can be handled by each of the deliverers, the deliverer in charge of the sectional routes, and the delivery cost and delivery time of the deliverer in charge of the sectional routes (step S10: acceptance step).

The sectional route generation function sections the route between the current location of the delivery requester (sender 1) and the delivery destination (recipient 4) in accordance with the deliverers 3 to generate a plurality of sectional routes (step S20: sectional route generation step).

The sectional route combination function combines a plurality of candidate sectional routes for the route from the current location of the delivery requester (sender 1) to the delivery destination (recipient 4) generated by the sectional route generation function, that is, the plurality of sectional routes between the current location of the delivery requester (sender 1) and the delivery destination (recipient 4) are combined with a plurality of corresponding deliverers 3 (step S30: sectional route combination step).

The deliverer selection function selects deliverers that can actually operate, that is, the deliverer in charge of delivery of each of the sectional routes is selected from among the deliverers on the basis of the package information and deliverer information to generate the delivery charge information (step S40: deliverer selection step). The deliverer selection function selects the deliverer in charge of delivery of each of the sectional routes from among a plurality of deliverers 3 on the basis of the package information and deliverer information in accordance with the threshold processing by the sectional route generation function and sectional route combination function described above, and generates the delivery charge information.

The transmission function transmits the delivery charge information to the delivery requester (sender 1) (step S50: transmission step).

The approval acquisition function acquires approval information from the delivery requester to approve the delivery charge information (step S60: approval acquisition step). The delivery plan for the request is finalized after the approval of the delivery charge information from the delivery requester.

The request function requests delivery operations to the deliverer in charge of the delivery of each of the sectional routes in accordance with the delivery charge information (step S70: request step). The delivery plan for the request is finalized after approval of the delivery charge information from the delivery requester, and only then are the individual deliverers requested to perform their own delivery operations.

The change acceptance function accepts a change of the sectional route included in the delivery charge information from the delivery requester and a change of the deliverer in that sectional route (step S80: change acceptance step in FIG. 9). If a change request is made by the delivery requester regarding the delivery charge information, the delivery charge information can be stopped from being finalized as it is. If a change request is made by the delivery requester, the process returns to the acceptance step (step S10) again, and the process described above is executed in accordance with the contents of the change.

The computer program of the present disclosure described above may be recorded on a recording medium readable by a processor, and the recording medium may be a “non-transitory tangible medium” such as a tape, disk, card, semiconductor memory, or programmable logic circuit.

The computer program described above may be implemented using, for example, scripting languages such as ActionScript and JavaScript (registered trademark), object-oriented programming languages such as Objective-C and Java (registered trademark), and markup languages such as HTML5.

According to the examples above, an appropriate deliverer may be selected for each section from among a plurality of deliverers to assist the management of goods deliveries in which a plurality of deliverers deliver goods.

### Other Examples

Although these examples describe a delivery management assist system for logistics providers to deliver goods, they may also be used as a management system for post offices to deliver mails.

### INCORPORATION BY REFERENCE

This application is a continuation application of International Application No. PCT/JP2022/000469, filed on Jan. 11, 2022, which claims priority of Japanese (JP) Patent Application No. 2021-076871, filed on April 28, 2021, the contents of which are hereby incorporated by reference in its entirety.

What is claimed is:

1. A delivery management assist system comprising:
a receiver that receives:
package information including at least destination, contents, weight, desired delivery amount of cost, and desired delivery time for delivery of a package requested by a delivery requester, and
deliverer information including at least a plurality of deliverers capable of delivering the package, a sectional route that each of the deliverers is capable of being in charge of delivery, a deliverer in charge of the sectional route, and delivery fee and delivery time of the deliverer in charge of the sectional route;
a sectional route generator that generates a plurality of sectional routes by sectioning a route between a current location of the delivery requester and the destination in accordance with the deliverers;
a sectional route combining unit that combines two or more of the sectional routes;
a deliverer selector that selects a deliverer in charge of delivery of each of the combined sectional routes from among the deliverers based on the package information and the deliverer information to generate delivery charge information; and
a transmitter that transmits the delivery charge information to the delivery requester.

2. The delivery management assist system according to claim 1, wherein the deliverer selector generates delivery charge information including the deliverer in charge of delivery of each of the sectional routes and an amount of cost and time needed for delivery of the package by the deliverer in charge of delivery of each of the sectional routes.

3. The delivery management assist system according to claim 1, wherein the deliverer selector selects a deliverer in accordance with the sectional route based on desired delivery amount of cost or desired delivery time from the package information.

4. The delivery management assist system according to claim 1, wherein the deliverer selector uses artificial intelligence AI to select a deliverer in charge of delivery of each of the sectional routes from among a plurality of deliverers based on the package information and the deliverer information through matching by natural language processing to generate delivery charge information.

5. The delivery management assist system according to claim 1, wherein the sectional route generator sets a threshold value for a distance or time of each of the sectional routes.

6. The delivery management assist system according to claim 1, wherein the deliverer selector selects a deliverer in charge of delivery of each of the combined sectional routes from among the deliverers by weighting process based on the package information and the deliverer information.

7. The delivery management assist system according to claim 1, further comprising:
an approval acquisition unit that acquires approval information from the delivery requester to approve the delivery charge information; and
a request unit that requests a delivery operation to the deliverer in charge of delivery of each of the sectional routes in accordance with the delivery charge information.

8. The delivery management assist system according to claim 1, wherein each of the deliverers has an accumulated evaluation value for delivery actions by another delivery requester, and the deliverer selector selects a deliverer with a higher evaluation value in preference to a deliverer with a lower evaluation value.

9. The delivery management assist system according to claim 1, further comprising a change receiver that receives a change of the sectional route included in the delivery charge information and a change of the deliverer in the sectional route from the delivery requester, wherein
the deliverer selector generates the delivery charge information again based on the changes.

10. A delivery management assist method that causes a computer to perform the steps of:
receiving:
package information including at least destination, contents, weight, desired delivery amount of cost, and desired delivery time for delivery of a package requested by a delivery requester, and
deliverer information including at least a plurality of deliverers capable of delivering the package, a sectional route that each of the deliverers is capable of being in charge of delivery, a deliverer in charge of the sectional route, and delivery fee and delivery time of the deliverer in charge of the sectional route;
generating a plurality of sectional routes by sectioning a route between a current location of the delivery requester and the destination in accordance with the deliverers;
combining two or more of the sectional routes generated in the sectional route generating step;
selecting a deliverer in charge of delivery of each of the sectional routes from among the deliverers based on the package information and the deliverer information to generate delivery charge information; and
transmitting the delivery charge information to the delivery requester.

11. A non-transitory computer readable medium storing therein a delivery management assist program that causes a computer to embody the functions of:
receiving:
package information including at least destination, contents, weight, desired delivery amount of cost, and desired delivery time for delivery of a package requested by a delivery requester, and
deliverer information including at least a plurality of deliverers capable of delivering the package, a sectional route that each of the deliverers is capable of being in charge of delivery, a deliverer in charge of the sectional route, and delivery fee and delivery time of the deliverer in charge of the sectional route;
generating a plurality of sectional routes by sectioning a route between a current location of the delivery requester and the destination in accordance with the deliverers;
combining two or more of the sectional routes generated by the sectional route generating function;
selecting a deliverer in charge of delivery of each of the sectional routes from among the deliverers based on the package information and the deliverer information to generate delivery charge information; and
transmitting the delivery charge information to the delivery requester.
